(19) United States
(12) Patent Application Publication
(10) Pub. No.: US 2015/0291074 A1
(43) Pub. Date: Oct. 15, 2015

(54) AUTOMOTIVE TUFTED CARPET

(71) Applicants: TOYOTA BOSHOKU KABUSHIKI KAISHA, Aichi-ken (JP); HASETORA SPINNING CO., LTD., Gifu (JP)

(72) Inventors: Kazunori Taguchi, Gifu (JP); Kengo Hatano, Gifu (JP); Atsuhiro Hattori, Aichi (JP); Kazuharu Hase, Gifu (JP)

(73) Assignees: TOYOTA BOSHOKU KABUSHIKI KAISHA, Aichi-ken (JP); HASETORA SPINNING CO., LTD., Gifu (JP)

(21) Appl. No.: 14/647,720

(22) PCT Filed: Dec. 2, 2013
(86) PCT No.: PCT/JP2013/082392

§ 371 Date: May 27, 2015

(30) Foreign Application Priority Data
Dec. 7, 2012 (JP) 2012-268507

(51) Int. Cl. B60N 3/04; D06N 7/00

(52) U.S. Cl. CPC B60N 3/048; D06N 7/0065

(57) ABSTRACT

The carpet is a tufted carpet for automobiles formed by implanting pile yarns into a base fabric, including: a high basis weight part having the pile yarns implanted at a high basis weight, a low basis weight part having the pile yarns implanted at a low basis weight lower than the high basis weight, and a middle basis weight part provided between the high basis weight part and the low basis weight part and having the pile yarns implanted at a basis weight between those of the high basis weight part and the low basis weight part. The basis weight of the middle basis weight part becomes smaller stepwise from the side adjacent to the high basis weight part toward the side adjacent to the low basis weight part.

### TECHNICAL FIELD

The present invention relates to a tufted carpet for automobiles, and more specifically to a tufted carpet for automobiles, which can make a border between a high basis weight part and a low basis weight part difficult to visually recognize and enables reduction in weight while enhancing design.

### BACKGROUND ART

As conventional tufted carpets for automobiles, those formed by implanting pile yarns into a base fabric are generally known (for example, see Patent Document 1). Patent Document 1 discloses, for example, a tufted carpet 101 comprising a high basis weight part 107 having pile yarns 105 implanted at a high basis weight (for example, 280 to 700 g/m²) and a low basis weight part 108 having pile yarns 105 implanted at a basis weight lower than the high basis weight (for example, 200 to 500 g/m²), the high basis weight part 107 and the low basis weight part 108 being arranged adjacent to each other, as shown in FIG. 7. This can enhance design due to the high basis weight part 107 which is a portion easy to see in a state where the carpet 101 is used, and also enables reduction in weight due to the low basis weight part 108 which is a portion hard to see.

### PRIOR ART DOCUMENT

### Patent Document

Patent Document 1: JP 2012-24457 A

### SUMMARY OF THE INVENTION

### Problem to be Solved by the Invention

However, the high basis weight part 107 and the low basis weight part 108 are arranged adjacent to each other in the tufted carpet 101 for automobiles of Patent Document 1 indicated above, and thus the border between the high basis weight part 107 and the low basis weight part 108 can be visually recognized like a line in a state where the carpet 101 is used, so that design is likely to be deteriorated.

The present invention has been made in light of the above actual situation, and an object thereof is to provide a tufted carpet for automobiles, which can make a border between a high basis weight part and a low basis weight part difficult to visually recognize and enables reduction in weight while enhancing design.

### Solutions to the Problem

In order to solve the above problem, the invention as defined in claim 1 relates to a tufted carpet for automobiles formed by implanting pile yarns into a base fabric, the tufted carpet including: a high basis weight part having the pile yarns implanted at a high basis weight; a low basis weight part having the pile yarns implanted at a low basis weight lower than the high basis weight; and a middle basis weight part provided between the high basis weight part and the low basis weight part and having the pile yarns implanted at a basis weight between those of the high basis weight part and the low basis weight part, and the tufted carpet being characterized in that the basis weight of the middle basis weight part becomes smaller stepwise from the side adjacent to the high basis weight part toward the side adjacent to the low basis weight part.

The invention as defined in claim 2 relates to the tufted carpet for automobiles according to claim 1, the tufted carpet being characterized in that the middle basis weight part has: a first middle basis weight part provided adjacent to the high basis weight part and having the pile yarns implanted in a predetermined first stitch number; and a second middle basis weight part provided adjacent to the low basis weight part and having the pile yarns implanted in a predetermined second stitch number smaller than the predetermined first stitch number.

The invention as defined in claim 3 relates to the tufted carpet for automobiles according to claim 1, the tufted carpet being characterized in that the stitch number of each stitch in the middle basis weight part becomes smaller stepwise from the side adjacent to the high basis weight part toward the side adjacent to the low basis weight part.

The invention as defined in claim 4 relates to the tufted carpet for automobiles according to any one of claims 1 to 3, the tufted carpet being characterized in that the middle basis weight part has 4 or more and 40 or less stitches.

### Effects of the Invention

The tufted carpet for automobiles according to the present invention includes a high basis weight part having the pile yarns implanted at a high basis weight, a low basis weight part having the pile yarns implanted at a low basis weight lower than the high basis weight, and a middle basis weight part provided between the high basis weight part and the low basis weight part and having the pile yarns implanted at a basis weight between those of the high basis weight part and the low basis weight part. The basis weight of the middle basis weight part becomes smaller stepwise from the side adjacent to the high basis weight part toward the side adjacent to the low basis weight part. The tufted carpet for automobiles of the present invention includes a high basis weight part and a low basis weight part in this manner, and thus can realize excellent texture and good appearance to enhance design due to the high basis weight part which is a portion easy to see in a state where the carpet is used, and also enables reduction in weight due to the low basis weight part which is a portion hard to see. Also, the middle basis weight part having a stepwise varying basis weight is provided between the high basis weight part and the low basis weight part, thereby making the border between the high basis weight part and the low basis weight part difficult to visually recognize.

When the middle basis weight part has: a first middle basis weight part provided adjacent to the high basis weight part and having the pile yarns implanted in a predetermined first stitch number; and a second middle basis weight part provided adjacent to the low basis weight part and having the pile yarns implanted in a predetermined second stitch number smaller than the predetermined first stitch number, it is possible to suitably form the middle basis weight part while simplifying the control of implanting of pile yarns by a tufting machine.

Also, when the stitch number of each stitch in the middle basis weight part becomes smaller stepwise from the side adjacent to the high basis weight part toward the side adjacent to the low basis weight part, the border between the high basis weight part and the low basis weight part can be more reliably made difficult to visually recognize.

Further, when the middle basis weight part has 4 or more and 40 or less stitches, due to the fact that the part has 4 or more stitches, the border can be sufficiently made difficult to visually recognize by the middle basis weight part, whereas, due to the fact that the part has 40 or less stitches, it is possible to relatively narrow the region of the middle basis weight part to accelerate the transition between the high basis weight part and the low basis weight part, thereby sufficiently reducing the weight.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a side view schematically showing a tufted carpet for automobiles according to an Example.

FIG. 2 is a perspective view schematically showing the tufted carpet.

FIG. 3 is an illustrative view for illustrating a process for manufacturing the tufted carpet.

FIG. 4 is an illustrative view for illustrating a process for manufacturing the tufted carpet.

FIG. 5 is an illustrative view for illustrating usage forms of the tufted carpet, in which (a) shows a form of the tufted carpet in which the basis weight is changed in the vehicle width direction; (b) shows a form of the tufted carpet in which the basis weight is changed in the vehicle length direction.

FIG. 6 is a side view schematically showing another form of the tufted carpet for automobiles.

FIG. 7 is an illustrative view for illustrating a conventional tufted carpet for automobiles.

### EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

1. Tufted Carpet for Automobiles

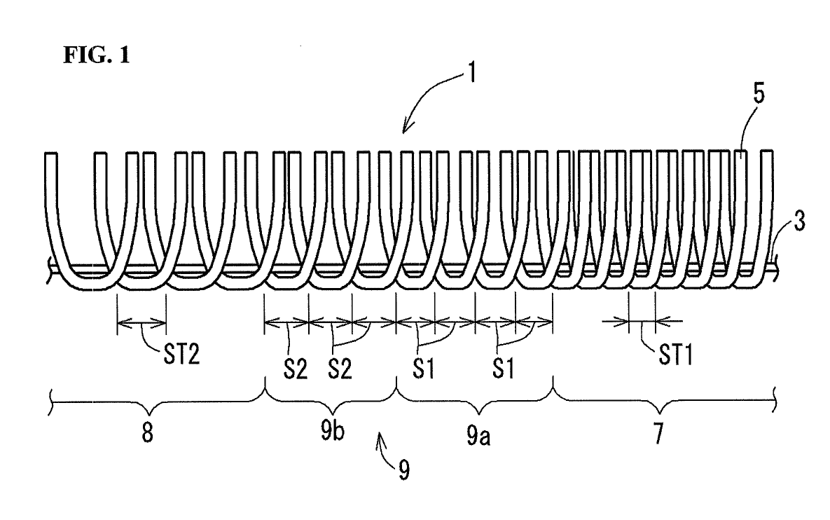

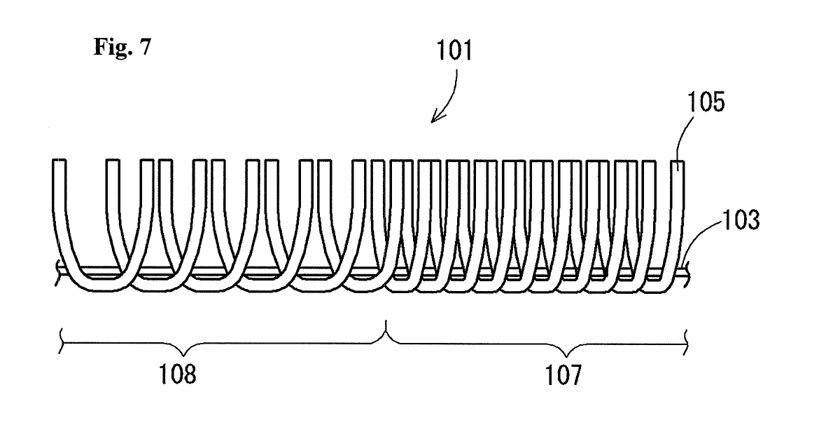

The tufted carpet for automobiles according to this embodiment 1 is a tufted carpet for automobiles (1, 21) formed by implanting pile yarns (5) into a base fabric (3), including: a high basis weight part (7) having the pile yarns implanted at a high basis weight, a low basis weight part (8) having the pile yarns implanted at a low basis weight lower than the high basis weight, and a middle basis weight part (9, 22) provided between the high basis weight part and the low basis weight part and having the pile yarns implanted at a basis weight between those of the high basis weight part and the low basis weight part. The basis weight of the middle basis weight part becomes smaller stepwise from the side adjacent to the high basis weight part toward the side adjacent to the low basis weight part (see, for example, FIG. 1 and FIG. 6). The above-described “basis weight” is intended to represent the weight of pile yarns per unit area of the base fabric.

For example, 280 to 700 g/m² can be indicated as the basis weight of the high basis weight part (7). Also, 200 to 500 g/m² can be indicated as an example of the basis weight of the low basis weight part (8). This basis weight of the low basis weight part is a value smaller than the basis weight of the high basis weight part.

Further, 240 to 600 g/m² can be indicated as an example of the average basis weight of the middle basis weight part (9, 22). This average basis weight of the middle basis weight part is a value smaller than the basis weight of the high basis weight part and larger than the basis weight of the low basis weight part.

A form in which the middle basis weight part (9) including a first middle basis weight part (9a) provided adjacent to the high basis weight part (7) and having the pile yarns implanted in a predetermined first stitch number, and a second middle basis weight part (9b) provided adjacent to the low basis weight part (8) and having the pile yarns implanted in a predetermined second stitch number smaller than the predetermined first stitch number (see, for example, FIG. 1) can be indicated as an example of the tufted carpet for automobiles according to this embodiment 1. The above-described “stitch number” is intended to represent the number of pile yarns pushed per inch (2.54 cm) in the stitch direction of the base fabric.

A form in which the stitch number of each stitch in the middle basis weight part (22) becomes smaller stepwise from the side adjacent to the high basis weight part (7) toward the side adjacent to the low basis weight part (8) (see, for example, FIG. 6) can be indicated as an example of the tufted carpet for automobiles according to this embodiment 1.

For example, 8.0 to 17.0 stitches/inch can be indicated as the stitch number of the high basis weight part (7). Also, 6.0 to 12.0 stitches/inch can be indicated as an example of the stitch number of the low basis weight part (8). This stitch number of the low basis weight part is a value smaller than the stitch number of the high basis weight part. Further, 7.0 to 14.5 stitches/inch can be indicated as an example of the average stitch number of the middle basis weight part (9, 22). This average stitch number of the middle basis weight part is a value smaller than the stitch number of the high basis weight part and larger than the stitch number of the low basis weight part.

A form in which the middle basis weight part (9, 22) has 4 or more and 40 or less stitches (S1, S2, Sa to Sg) (see, for example, FIG. 1 and FIG. 6) can be indicated as an example of the tufted carpet for automobiles according to this embodiment 1.

The parenthetic reference numerals for the respective components described in the above-described embodiment are intended to indicate the correspondence relationship with the specific configurations described in Examples given below.

### EXAMPLES

Hereinafter, the present invention will be explained in detail by way of Examples 1 and 2 with reference to the drawings.

### Example 1

### (1) Configuration of tufted carpet for automobiles

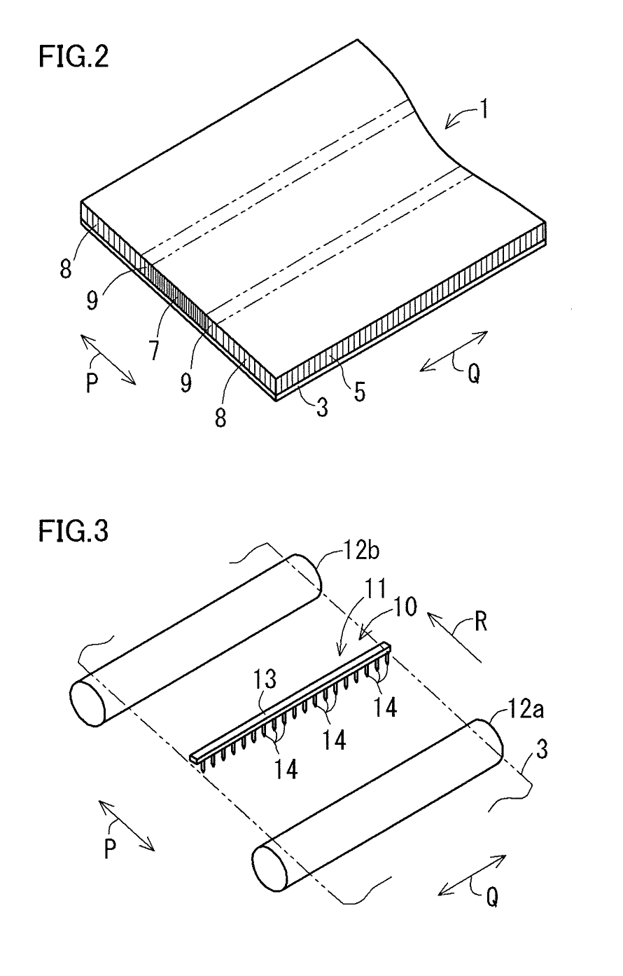

A tufted carpet 1 for automobiles according to this Example is formed by implanting pile yarns 5 into a base fabric 3 made of polyester or the like by a tufting machine described below, as shown in FIG. 1 and FIG. 2. Examples of the material for the pile yarns 5 can include nylon (polyamide), polyester and polypropylene or the like. Also, 900 to 1500 dtex can be indicated as an example of the thickness of the pile yarns 5.

The tufted carpet 1 includes a high basis weight part 7 having the pile yarns 5 implanted at a high basis weight, a low basis weight part 8 having the pile yarns implanted at a basis weight lower than the high basis weight, and a middle basis weight part 9 provided between the high basis weight part 7 and the low basis weight part 8 and having the pile yarns 5 implanted at a basis weight between those of the high basis weight part 7 and the low basis weight part 8.

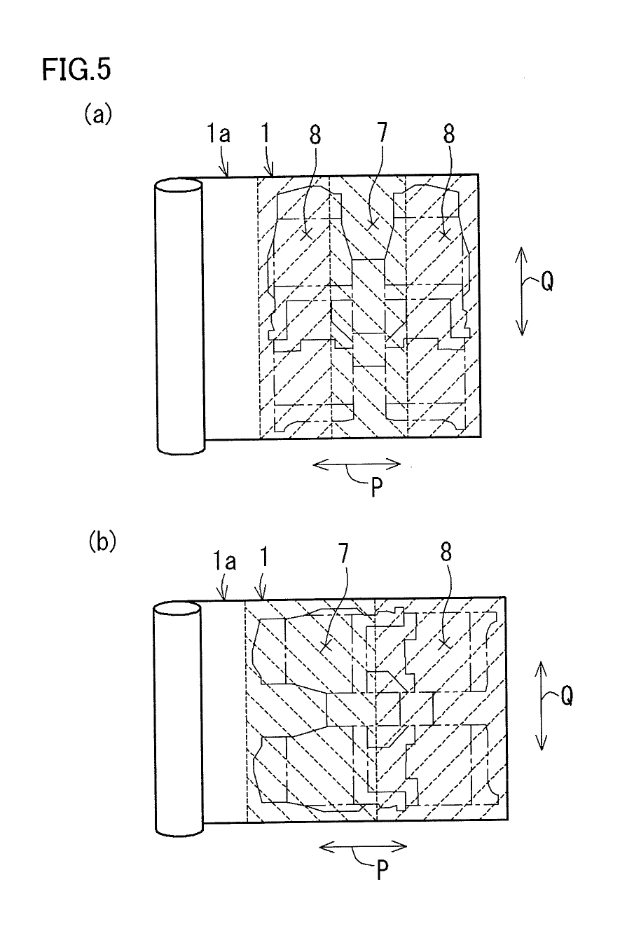

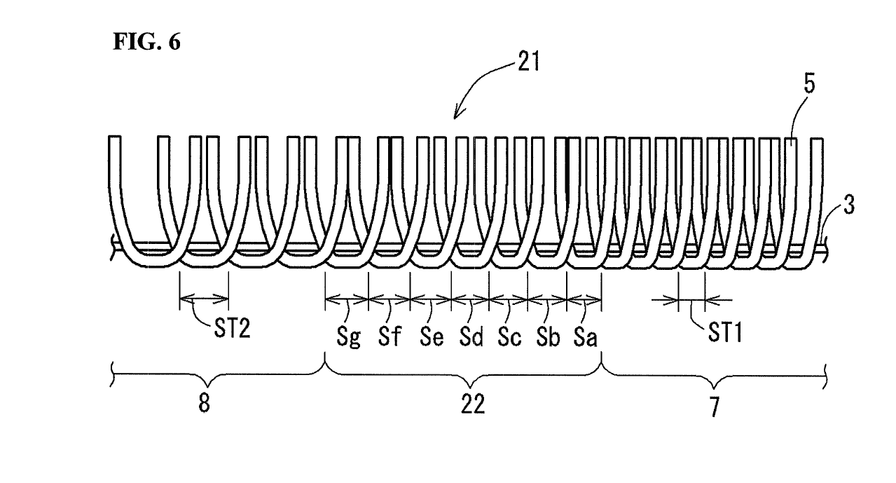

The high basis weight part 7 and low basis weight part 8 are arranged along the vehicle width direction (namely, stitch direction P), as shown in FIG. 2 and FIG. 5 (a). This high basis weight part 7 is arranged on the central side of the vehicle width direction, and the low basis weight part 8 is arranged on both lateral sides of the vehicle width direction. In FIG. 5, the tufted carpet for automobiles after shaping is shown by two-dot chain lines.

The high basis weight part 7 is composed of the pile yarns 5 implanted in a predetermined stitch number (for example, about 12.5 stitches/inch), and has many stitches ST1, as shown in FIG. 1. The basis weight of this high basis weight part 7 is defined as about 360 g/m². Also, the low basis weight part 8 is composed of the pile yarns 5 implanted in a predetermined stitch number (for example, about 9.4 stitches/inch), and has many stitches ST2. The basis weight of this low basis weight part 8 is defined as about 285 g/m².

The basis weight of the middle basis weight part 9 becomes smaller stepwise from the side adjacent to the high basis weight part 7 toward the side adjacent to the low basis weight part 8. Specifically, the middle basis weight part 9 has a first middle basis weight part 9a provided adjacent to the high basis weight part 7, and a second middle basis weight part 9b provided adjacent to the low basis weight part 8. This first middle basis weight part 9a has the pile yarns 5 implanted in a predetermined first stitch number (for example, about 11.5 stitches/inch), and has 2 or more (4 in FIG. 1) stitches S1. Also, the second middle basis weight part 9b has the pile yarns 5 implanted in a predetermined second stitch number (for example, about 10.4 stitches/inch) smaller than the predetermined first stitch number, and has 2 or more (3 in FIG. 1) stitches S2.

The basis weight of the first middle basis weight part 9a is defined as about 335 g/m, and the basis weight of the second middle basis weight part 9b is defined as about 310 g/m². Further, the respective stitch numbers of S1 and S2 which constitute the middle basis weight part 9 are smaller than the stitch number of stitch ST1 which constitutes the high basis weight part 7 and larger than the number of the stitch ST2 which constitutes the low basis weight part 8.

Here, the basis weights of the respective basis weight parts 7, 8 and 9 described above are determined depending on the stitch number, length of the pile yarns 5, gauge number and fineness (thickness) of the pile yarns. The stitch number represents the number of the pile yarns 5 pushed per inch (2.54 cm) in the stitch direction P of the base fabric 3. Also, the length of the pile yarns 5 represents the length of the pile yarns 5 protruding from the surface of the base fabric 3, and is appropriately set according to the intended use and purpose of the tufted carpet 1. Also, the above-described gauge number represents the density of the pile yarns 5 in the gauge direction Q of the base fabric 3, which is fixed depending on the tufting machine and is not changed in general. A second base fabric, felt, film or the like, which are not shown, are bonded on the back surface side of the tufted carpet 1 as necessary.

### (2) Process for manufacturing tufted carpet for automobiles

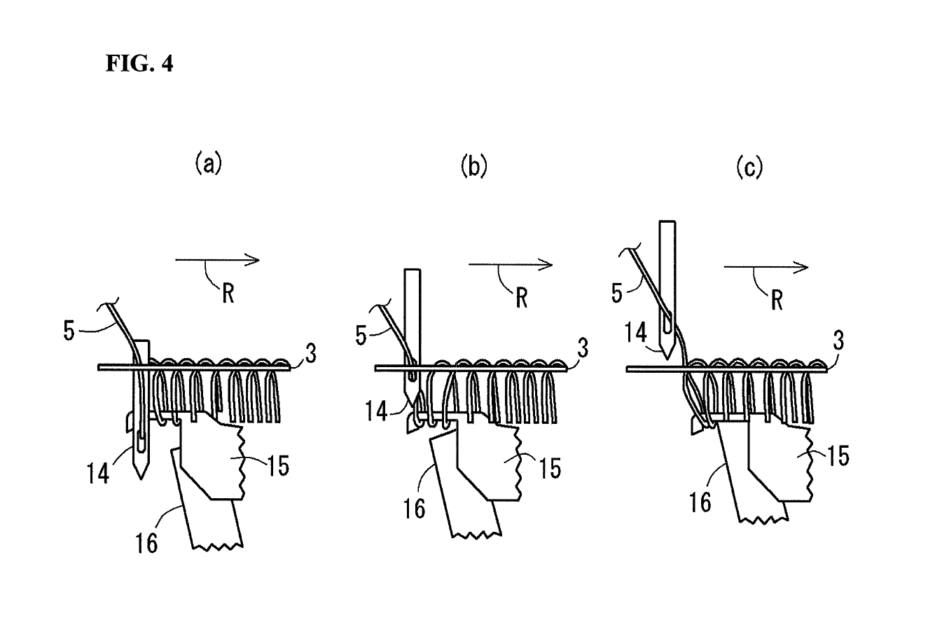

Next, the process for manufacturing the tufted carpet 1 for automobiles having the above-described configuration will be explained. A tufting machine 10 includes a tuft part 11 which implants the pile yarns 5 into the base fabric 3 and a feed roller 12a, 12b driven to feed the base fabric 3 to this tuft part 11, as shown in FIG. 3. This tuft part 11 comprises an elongated needle bar 13, a plurality of needles 14 provided on the lower surface side of this needle bar 13, a looper 15 and a knife 16 (see FIG. 4).

In the tuft part 11, a series of operations of sticking the needle 14 threaded with the pile yarns 5 in the base fabric 3 as shown in FIG. 4 (a), then extracting the needle 14 while retaining the pile yarns 5 by means of the looper 15 as shown in FIG. 4 (b), and then elevating the knife 16 to cut the tip ends of the piles as shown in FIG. 4 (c) are repeated in the state where the base fabric 3 is fed in the feeding direction R at a predetermined feeding speed. As a result, the pile yarns 5 are pushed through the base fabric 3 in the stitch direction P and the gauge direction Q to form an original fabric 1a of the tufted carpet 1 (see FIG. 5 (a)). This original fabric 1a would be cut to be used for each vehicle to form the tufted carpet 1.

Here, in the tufting machine 10, when the respective basis weight parts 7, 8 and 9 are formed, the speed of pushing the pile yarns 5 by the needle 14 is made constant, and the speed of feeding the base fabric 3 is changed. Specifically, the speed of feeding the base fabric 3 employed in the formation of the first middle basis weight part 9a is made faster than that employed in the formation of the high basis weight part 7; the speed of feeding the base fabric 3 employed in the formation of the second middle basis weight part 9b is made faster than that employed in the formation of the first middle basis weight part 9a; and the speed of feeding the base fabric 3 employed in the formation of the low basis weight part 8 is made faster than that employed in the formation of the second middle basis weight part 9b. This would change the amount of the pile yarns 5 pushed to form the respective basis weight parts 7, 8 and 9. Also, the speed of feeding the base fabric 3 may be made constant, and the speed of pushing the pile yarns 5 by the needle 14 may be changed. Specifically, the speed of pushing the pile yarns 5 (in other words, the number of pushing rotations of the pile yarns 5) employed in the formation of the first middle basis weight part 9a is made slower (the number of pushing rotations is smaller) than that employed in the formation of the high basis weight part 7; the speed of pushing the pile yarns 5 employed in the formation of the second middle basis weight part 9b is made slower (the number of pushing rotations is smaller) than that employed in the formation of the first middle basis weight part 9a; and the speed of pushing the pile yarns 5 employed in the formation of the low basis weight part 8 is made slower (the number of pushing rotations is smaller) than that employed in the formation of the second middle basis weight part 9b. However, it is more preferable to make the speed of pushing the pile yarns 5 by the needle 14 constant at the maximum value of the ability of the tufting machine 10 and to change the speed of feeding the base fabric 3, from the viewpoint of productivity of tufting.

### (3) Action of Tufted Carpet for Automobiles

Next, the action of the tufted carpet for automobiles having the above-described configuration will be explained. In this tufted carpet 1, design is enhanced by providing the high basis weight part 7 on the central side of the vehicle width direction, and the reduction in weight is ensured by providing the low basis weight part 8 on both lateral sides of the vehicle width direction covered with a floor mat, as shown in FIG. 5(a). Also, the tufted carpet 1 includes the middle basis weight part 9 having a stepwise varying basis weight between those of the high basis weight part 7 and the low basis weight part 8 as shown in FIG. 1 and FIG. 2, so that it is difficult for passengers to visually recognize the border between the high basis weight part 7 and the low basis weight part 8.

### (4) Effects of Example

As described above, the tufted carpet 1 for automobiles of this Example includes a high basis weight part 7 having the pile yarns 5 implanted at a high basis weight; a low basis weight part 8 having the pile yarns 5 implanted at a low basis weight lower than the high basis weight; and a middle basis weight part 9 provided between the high basis weight part 7 and the low basis weight part 8 and having the pile yarns 5 implanted at a basis weight between those of the high basis weight part 7 and the low basis weight part 8. The basis weight of the middle basis weight part 9 becomes smaller stepwise from the side adjacent to the high basis weight part 7 toward the side adjacent to the low basis weight part 8. The tufted carpet 1 includes the high basis weight part 7 and the low basis weight part 8 in this manner, and thus can realize excellent texture and good appearance to enhance design due to the high basis weight part 7 which is a portion easy to see in a state where the carpet is used, and also enables reduction in weight due to the low basis weight part 8 which is a portion hard to see. Also, the middle basis weight part 9 having a stepwise varying basis weight is provided between the high basis weight part 7 and the low basis weight part 8, so that the border between the high basis weight part 7 and the low basis weight part 8 can be made difficult to visually recognize.

Also, in this Example, the middle basis weight part 9 has: a first middle basis weight part 9a provided adjacent to the high basis weight part 7 and having the pile yarns 5 implanted in a predetermined first stitch number; and a second middle basis weight part 9b provided adjacent to the low basis weight part 8 and having the pile yarns 5 implanted in a predetermined second stitch number smaller than the predetermined first stitch number. Thus, it is possible to suitably form the middle basis weight part 9 while simplifying the control of implanting of the pile yarns 5 by the tufting machine 10.

Further, in this Example, the middle basis weight part 9 has 4 or more and 40 or less (7 in FIG. 1) stitches S1, S2. Thus, due to the fact that the part has 4 or more stitches S1, S2, the border can be sufficiently made difficult to visually recognize by the middle basis weight part 9, whereas, due to the fact that the part has 40 or less stitches S1, S2, it is possible to relatively narrow the region of the middle basis weight part 9 to accelerate the transition between the high basis weight part 7 and the low basis weight part 8, thereby sufficiently reducing the weight.

### Example 2

Next, a tufted carpet for automobiles according to this Example 2 will be explained. In the tufted carpet for automobiles according to this Example 2, the same reference numerals are attached to the component sites approximately the same as those of the tufted carpet 1 for automobiles according to Example 1 described above for omission of detailed explanation.

### (1) Configuration of Tufted Carpet for Automobiles

A tufted carpet 21 for automobiles according to this Example includes a high basis weight part 7 having the pile yarns 5 implanted at a high basis weight; a low basis weight part 8 having the pile yarns 5 implanted at a basis weight lower than the high basis weight; and a middle basis weight part 22 provided between the high basis weight part 7 and the low basis weight part 8 and having the pile yarns 5 implanted at a basis weight between those of the high basis weight part 7 and the low basis weight part 8, as shown in FIG. 6.

The basis weight of the middle basis weight part 22 becomes smaller stepwise from the side adjacent to the high basis weight part 7 toward the side adjacent to the low basis weight part 8. Specifically, the stitch number of each stitch in the middle basis weight part 22 becomes smaller stepwise from the side adjacent to the high basis weight part 7 toward the side adjacent to the low basis weight part 8. This middle basis weight part 22 is composed of the pile yarns 5 implanted in stitch numbers different for each stitch, and has 4 or more (7 in FIG. 6) stitches Sa to Sg. The average stitch number of the middle basis weight part 22 is defined as about 11.0 stitches/inch.

### (2) Process for Manufacturing Tufted Carpet for Automobiles

Next, the process for manufacturing the tufted carpet 21 for automobiles having the above-described configuration will be explained. In the tufting machine 10, when the respective basis weight parts 7, 8 and 22 are formed, the speed of pushing the pile yarns 5 by the needle 14 is made constant, and the speed of feeding the base fabric 3 is changed. The speed of feeding the base fabric 3 employed in the formation of the low basis weight part 8 is made faster than that employed in the formation of the high basis weight part 7, and the speed of feeding the base fabric 3 in the formation of the middle basis weight part 22 is made gradually faster or slower for each stitch S. Due to this, the amount of the pile yarns 5 pushed is changed to form the respective basis weight parts 7, 8 and 22.

### (3) Effects of Example

As described above, the tufted carpet 21 for automobiles of this Example provides the function/effect approximately similar to that of the tufted carpet 1 for automobiles of Example 1. Also, since the basis weight of the middle basis weight part 22 becomes smaller stepwise from the side adjacent to the high basis weight part 7 toward the side adjacent to the low basis weight part 8, the border between the high basis weight part 7 and the low basis weight part 8 can be more reliably made difficult to visually recognize.

The present invention is not limited to the above-described Examples, and can take Examples variously changed within the scope of the present invention depending on the purpose and intended use. Specifically, a form in which one tufted carpet 1, 21 includes a single high basis weight part 7 has been illustrated in Examples 1 and 2 described above. However, the present invention is not limited to this, and, for example, one tufted carpet may include two or more high basis weight parts. For example, in the tufted carpet 1 shown in FIG. 5 (a), the outer part in the vehicle width direction of both the low basis weight parts 8 may be defined as the high basis weight parts.

Also, the tufted carpet 1, 21 in which the high basis weight part 7 and low basis weight part 8 are arranged along the vehicle width direction (namely, stitch direction P), the high basis weight part 7 is arranged on the central side of the vehicle width direction, and the low basis weight part 8 is arranged on both lateral sides of the vehicle width direction has been illustrated in Examples 1 and 2 described above. However, the present invention is not limited to this, and may employ, for example, a tufted carpet in which the high basis weight part 7 and low basis weight part 8 are arranged along the vehicle length direction (namely, stitch direction P), the high basis weight part 7 is arranged on the vehicle front side, and the low basis weight part 8 is arranged on the vehicle back side, as shown in FIG. 5 (b). In this case, design is enhanced by providing the high basis weight part 7 on the vehicle front side, and the reduction in weight is ensured by providing the low basis weight part 8 on the vehicle back side which is low in riding frequency and shaping elongation rate. Further, the present invention may employ a tufted carpet in which a high basis weight part is arranged on the vehicle back side and a low basis weight part is arranged on the vehicle front side.

Also, the basis weights and stitch numbers of the high basis weight part 7, low basis weight part 8 and middle basis weight part 9, 22 in Examples 1 and 2 described above can be appropriately set depending on the thickness and length of the pile yarns.

In Example 1 described above, the middle basis weight part 9 including the first and second middle basis weight parts 9a and 9b has been illustrated. However, the present invention is not limited to this, and, for example, one or two or more additional middle basis weight part(s) having a basis weight between those of the first and second middle basis weight parts 9a and 9b may be provided between the two parts 9a and 9b.

Further, cut piles having a cut tip end have been illustrated in Examples 1 and 2 described above. However, the present invention is not limited to this, and, for example, loop piles having an uncut tip end may be employed.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above-described embodiments, and various variations and modifications may be possible without departing from the scope of the present invention.

### INDUSTRIAL APPLICABILITY

The present invention is widely utilized as a technique relating to a floor carpet which constitutes the floor surface of an automobile.

### DESCRIPTION OF REFERENCE SIGNS

1, 21: Tufted carpet for automobiles
3: Base fabric
5: Pile yarns
7: High basis weight part
8: Low basis weight part
9, 22: Middle basis weight part
9a: First middle basis weight part
9b: Second middle basis weight part
S1, S2, Sa to Sg: Stitch

1. A tufted carpet for automobile formed by implanting pile yarns into a base fabric, comprising:
a high basis weight part having the pile yarns implanted at a high basis weight;
a low basis weight part having the pile yarns implanted at a low basis weight lower than the high basis weight; and
a middle basis weight part provided between the high basis weight part and the low basis weight part and having the pile yarns implanted at a basis weight between those of the high basis weight part and the low basis weight part,
wherein the basis weight of the middle basis weight part becomes smaller stepwise from the side adjacent to the high basis weight part toward the side adjacent to the low basis weight part.

2. The tufted carpet for automobiles according to claim 1, wherein the middle basis weight part has: a first middle basis weight part provided adjacent to the high basis weight part and having the pile yarns implanted in a predetermined first stitch number; and a second middle basis weight part provided adjacent to the low basis weight part and having the pile yarns implanted in a predetermined second stitch number smaller than the predetermined first stitch number.

3. The tufted carpet for automobiles according to claim 1, wherein the stitch number of each stitch in the middle basis weight part becomes smaller stepwise from the side adjacent to the high basis weight part toward the side adjacent to the low basis weight part.

4. The tufted carpet for automobiles according to claim 1, wherein the middle basis weight part has 4 or more and 40 or less stitches.
